(19) United States
(12) Patent Application Publication
(10) Pub. No.: US 2014/0138512 A1
(43) Pub. Date: May 22, 2014

(54) CLEANING SYSTEM AND DISPLAY

(71) Applicant: THE PROCTER & GAMBLE COMPANY, Cincinnati, OH (US)

(72) Inventors: John Charles Van Rens, Cincinnati, OH (US); Michael Schmidt, Cincinnati, OH (US)

(73) Assignee: The Procter & Gamble Company, Cincinnati, OH (US)

(21) Appl. No.: 13/678,851

(22) Filed: Nov. 16, 2012

(51) Int. Cl. A47L 13/42; F16M 11/00

(52) U.S. Cl. CPC A47L 13/42; F16M 11/00
USPC 248/512; 15/231

(57) ABSTRACT

A cleaning system that is appealing to consumers while utilizing display space in a store, the system containing a head and handle, wherein the handle comprises a first segment and a second segment located in a sleeve holding the first and second segments together in a generally aligned relationship, the sleeve further containing at least one cleaning refill.

### FIELD OF THE INVENTION

The present invention relates to a cleaning system that is appealing to consumers while improving display space in a store, the system containing an implement having a head and handle, wherein the handle comprises a first segment and a second segment located in a sleeve holding the first and second segments together in a generally aligned relationship, the sleeve further containing at least one cleaning refill.

### BACKGROUND OF THE INVENTION

Cleaning products are well known in the art. Branded cleaning products include Swiffer® cleaning products, sold by the instant assignee. Swiffer® cleaning products include Swiffer® Dusters®, usable for cleaning for a variety of surfaces. Swiffer® cleaning products particularly include Swiffer® Sweeper® dry cleaning cloths, Swiffer® WetJet® pads and Swiffer® Wet cleaning cloths, usable for cleaning a floor and similar target surfaces.

These cleaning products typically comprise an implement and a refill. The implement is typically reused for many cleaning cycles. The refill is typically used for one cleaning cycle, and then discarded. A new refill may be used for the next cleaning cycle.

The implement usually comprises a handle containing multiple segments which are assembled to provide handles having various lengths so that the consumer can clean a variety of far reaching or near reaching surfaces. Previously these handles were either assembled pre-sale so that consumers bought a fully operational implement, or the entire implement was sold unassembled in a box. Fully assembled implements with fully extended handles provided challenges for both the stores selling the implements and for the consumers buying the implements. For stores, the fully assembled implements decreased the amount of shelf space that was available for displaying the implements and their related refills. As such, stores were forced to stock refills away from their respective implements which led to consumer confusion. For consumers, the fully assembled implements were harder to transport from stores into their homes. However, for implements that were sold completely unassembled in a box, consumers were unable to see what they were purchasing and had to exert undue user effort to assemble.

A need exists for a cleaning product that improves in-store shelf space and allows for corresponding cleaning refills to be located below the cleaning implements. In addition, a need exists for a cleaning implement that is able to be quickly and easily assembled by a consumer after purchase.

### SUMMARY OF THE INVENTION

The present invention provides for a cleaning system, said cleaning system comprising a head and handle, said handle comprising a first segment and a second segment, said first segment being articulably joined to said head, and said second segment being rigidly joinable to said first segment, wherein said first segment and said second segment are juxtaposed in a generally aligned relationship, and further comprising a sleeve holding said first and second segments together in said generally aligned relationship, said sleeve further containing at least one cleaning refill removably attachable to said head, wherein at least a portion of said head is external to said sleeve.

The present invention also provides for a cleaning system as displayed for sale, said cleaning system comprising a head and handle joined thereto, said handle comprising a first segment and a second segment, said first segment being articulably joined to said head, and said second segment being rigidly joinable to said first segment, wherein said first segment and said second segment are juxtaposed in a generally aligned relationship for sale, wherein the cleaning implement is further disposed on a rigid panel with shrink wrap there around to hold said first and second segments in said juxtaposed relationship, and further containing at least one cleaning refill disposed on said panel.

The present invention further provides for an array of cleaning systems for sale, each of said cleaning systems comprising a head and handle for sale, said handle comprising a first segment and a second segment, said first segment being articulably joined to said head, and said second segment being rigidly joinable to said first segment, wherein said first segment and said second segment are juxtaposed in a generally aligned relationship, and further comprising a cellulosic parallela pipedally shaped sleeve having a major axis generally aligned with said first and second segments, and holding said first and second segments together, said sleeve further containing at least one cleaning refill, wherein said array comprises a plurality of said cleaning systems disposed at a first height and a plurality of cleaning system refills useable with said cleaning systems and disposed at a second height, said second height being lower than said first height, so that said systems are disposed above respect refills usable therewith.

### BRIEF DESCRIPTION OF THE DRAWINGS

The detailed description of the drawings particularly refers to the accompanying figures in which:

FIG. 1 is a frontal view of a cleaning system for a sweeper;

FIG. 2 is a frontal view of a cleaning system for a spray implement;

FIG. 3 is a frontal view of a cleaning system for a duster;

FIG. 4A is a schematic frontal cutaway view of a sleeve having handle segments and a refill therein;

FIG. 4B is a schematic bottom view of the sleeve of FIG. 4A taken in the direction of 4B;

FIG. 5A is a schematic perspective view of a collar having two opening inserted into the sleeve;

FIG. 5B is a schematic perspective view of a sleeve with two collars each having two openings inserted into the sleeve;

FIG. 6 is a schematic front view of a collar having one opening inserted into the sleeve;

FIG. 7A is a schematic frontal view of a sleeve with a panel and shrink-wrap;

FIG. 7B is a schematic bottom view of the sleeve of FIG. 7A taken in the direction of 7B;

FIG. 8 is a schematic perspective view of a third embodiment of a sleeve; and

FIG. 9 is a frontal view of an exemplary array of cleaning systems according to the present invention.

### DETAILED DESCRIPTION

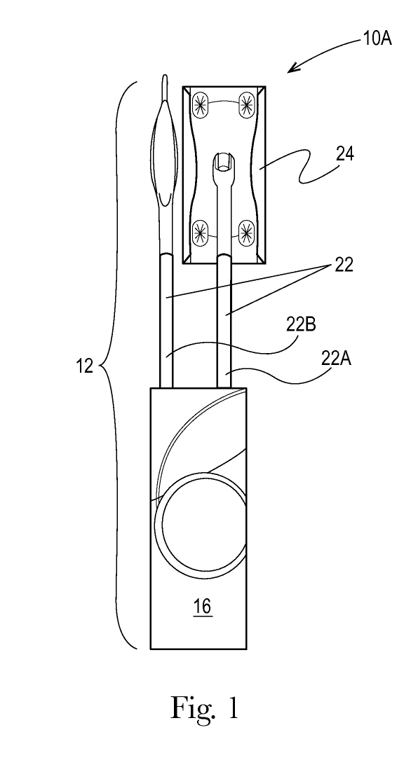

Referring jointly to FIGS. 1, 2 and 3, cleaning systems 10 (specifically, 10A, 10B, and 10C) are well known in the art. A general class of cleaning systems 10 removes dust and small debris from hard surfaces. This class of cleaning systems includes floor cleaning systems 10A and 10B, and duster cleaning systems 10C. Each of these two types of cleaning systems 10 may include a reusable implement 12 and a single-use, or limited use, cleaning refill 14 (not pictured) located in a sleeve 16. Cleaning systems 10A,B,C allow consumers to see the implements they are purchasing without the burden of having to transport a fully assembled implement while also providing the consumer with fewer segments to assemble.

The cleaning system 10 according to the present invention may comprise a multiply reusable implement 12, a cleaning refill 14 (not shown), and a sleeve 16. The implement 12, as noted above, has a handle 22 and a head portion 24. The handle 22 comprises a first segment 22A and a second segment 22B. In another embodiment, the handle 22 may comprises more than two segments; in another embodiment, more than three segments. The first segment 22A is articulably joined to the head portion 24 of the implement 12, while the second segment 22B may be rigidly joinable to the first segment 22A. The second segment 22B is rigidly joinable to the first segment 22A by snap locking or other known means. The first segment 22A and second segment 22B are juxtaposed in a generally aligned relationship by a sleeve 16 holding the first segment 22A and the second segment 22B. The head portion 24 of the implement 12 may be at least partially external to the sleeve 16. In another embodiment, the head portion 24 is fully external to the sleeve 16 which allows the consumer to see what the implement looks like before purchase. In another embodiment, the head portion 24 is fully contained in the sleeve 16 which provides added protection to the head portion 24. The sleeve 16 may further contain at least one cleaning refill 14 (not pictured).

The cleaning refill 14 is the portion of the implement 12 which gathers and retains debris cleaned from a target surface. The cleaning refill 14 is replaced, as needed. The cleaning refill 14, as noted above, is removably attached to the head portion 24 of the implement 12. When the refill 14 is in position on the head portion 24 of the implement 12 and is facing forward, the head portion 24 may or may not be visible to the user. The implement 12 is the portion of the cleaning system 10 which provides ergonomic convenience for the user, length to reach into places the user could not clean without undue extension, and temporary attachment of the refill 14 thereto.

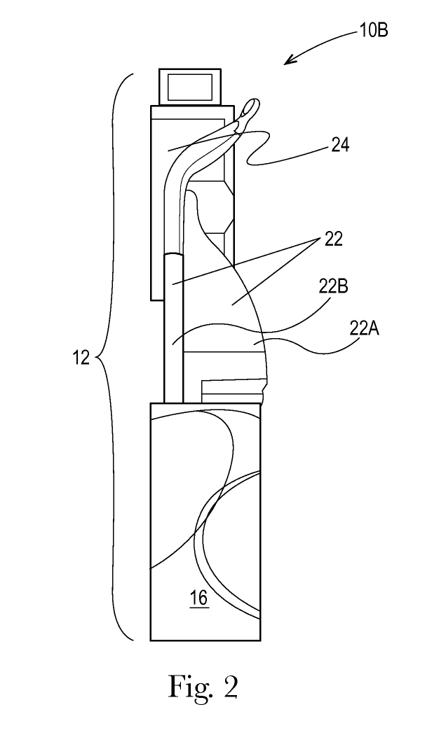

Referring to FIG. 1 and FIG. 2, one type of cleaning refill 14 includes cleaning pads usable for floor cleaning. Such pads are used for cleaning a target surface, such as a hard floor, wall or other hard surface. Flooring commonly cleaned with such a pad includes linoleum, tile, wood, etc.

The pad for cleaning a floor may be a conveniently sized sheet. The sheet may include a tissue grade of paper, a synthetic nonwoven, or combination thereof, as is known in the art. If desired, the pad may comprise a textured nonwoven. It is believed that the texture in this particular cleaning refill 14 helps to trap debris, for removal from the target surface and ultimate discarding with the disposable refill. A suitable cleaning refill 14 for floor cleaning systems 10A and 10B may be made according to commonly assigned U.S. Pat. Nos. 6,797,357; 6,936,330; D489,537; D499,887 and/or D511,251 S.

For convenience, the cleaning pad and cleaning refill 14 may be removably attached to a cleaning implement 12. The cleaning implement 12 may have an elongated handle 22 for grasping by the user. The handle 22 may be attached to a head portion 24 by universal joint. The head portion 24 may serve as the attachment portion of the implement 12. Suitable configurations for the cleaning implement 12 are shown in commonly assigned 2002/0042962 A1; Des. 409,343; Des. 423,724; D522,201 S; D554,815 S and/or D564,164 S. Alternatively the handle 22 and head portion 24 may be in fixed relationship, as often occurs with a loop handle. A suitable handle 22 may be made according to commonly assigned D552,314 S; D561,417 S; D571,069 S; and/or D578,720 S. The implement 12 may be assisted with a vacuum, as taught by U.S. Pat. No. 7,137,169 B2 and/or 7,293,322 B2. The implement 12 may also be a steam mop.

The cleaning pad may be removably attached to the bottom of the head portion 24, for movement relative to the target surface during cleaning. Attachment may be accomplished using one or more grippers. Suitable grippers may be made according to commonly assigned U.S. Pat. Nos. 6,305,046; 6,484,346; and/or 6,651,290. Alternatively the pad may be removably adhesively attached or removably attached using hook and loop fasteners. Suitable cleaning implements 12 include the Swiffer® Sweeper and Swiffer® SweeperVac® sold by the instant assignee.

The pads and refills 14 may also be used with water, or another cleaning solution to solubilize debris on the floor. The pads may be wetted and/or cleaning fluid may be distributed onto the floor from a reservoir. One suitable cleaning implement 12 for cleaning with a pad and distributing cleaning fluid from a replaceable reservoir includes the Swiffer® WetJet® implement 12 sold by the instant assignee. Such an implement 12 may be made according to commonly assigned U.S. Pat. Nos. 5,960,508; 6,386,392 B1; 6,663,306 B2; 6;722;806 B2; 7;172;099 B2; D487;174 S; D518,935 S and/or D574,565 S.

The cleaning refill 14 may be used in conjunction with a refill 14 comprising liquid cleaner. The liquid cleaner may be provided in a reservoir. A suitable liquid cleaner may be made according to commonly assigned: U.S. Pat. No. 6,380,151, U.S. Pat. No. 6,979,371, U.S. Pat. No. 6,716,805; U.S. Pat. No. 6,936,580; U.S. 2005/0133174A1; U.S. 2005/0113277A1; U.S. Pat. No. 7,470,656; U.S. Pat. No. 6,559,116; U.S. Pat. No. 6,730,654; U.S. Pat. No. 7,331,355; and U.S. 2007/0110699A1

The reservoir may be operably associated with the implement 12, so that cleaner can be distributed on demand from the implement 12 to the target surface. A suitable reservoir usable as a cleaning refill 14 with the present invention may be made according to commonly assigned U.S. Pat. No. 6,971,589; U.S. D467,809; U.S. D484,804; U.S. D485,178; U.S. D421,222; U.S. D456,268, and/or U.S. D492,203.

Alternatively, a suitable pre-wetted cleaning pad may be used for the cleaning refill 14. Such a pad includes the Swiffer® Sweeper Wet Cloths sold by the instant assignee. A suitable pad for absorbing deposited fluid may have an absorbent core, and be made generally according to the teachings of commonly assigned U.S. Pat. Nos. 5,960,508; 6,003,191; 6,101,661 and/or 6,766,552.

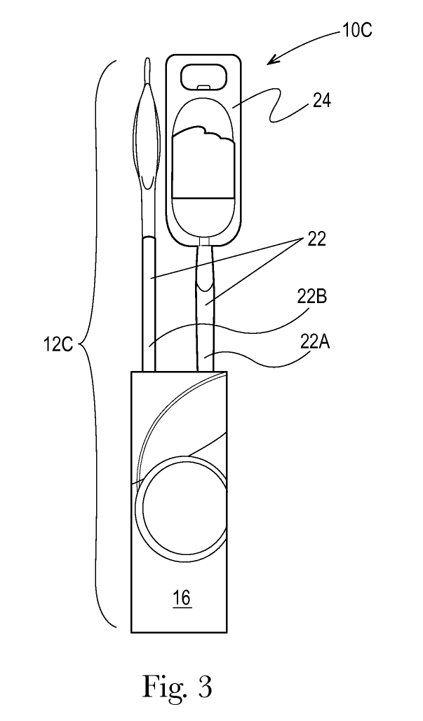

FIG. 3 is a second type of cleaning system, in this embodiment a duster cleaning system 10C, which includes a duster implement 12C, duster cleaning refill 14 (not shown), and sleeve 16 usable for cleaning dust from a target surface such as shelving, tables, countertops, and from/between objects such as pictures, knick-knacks, electronics, etc.

The duster implement 12C may comprise two primary components: a handle 22 comprising a first segment 22A and a second segment 22B, and a duster head 24 with a sheet with a plurality of fibers attached thereto. The fibers may comprise soft, pliable tow fibers as is known in the art. The sheet may comprise one or more layers of a nonwoven. The sheet and tow fibers may be joined together for removably accepting attachment to a handle 22 along a longitudinal axis. One common configuration is to have two adjacent, parallel elongate openings in the fibers for receiving the attachment portion of the duster implement 12C. A suitable duster implement 12C may be made according to U.S. Pat. Nos. 6,813,801 B2; 7,451,517 and/or 2002/0148061 A1.

The duster implement 12C may optionally have one or more gather strips. The gather strips may extend transversely from the longitudinal axis, to provide additional flexible surface area for cleaning confined spaces. A suitable configuration for the gather strips is found in commonly assigned D573,763 S; D573,764 S; D590,116 S and D591,017 S.

The duster implement 12C has a handle 22 wherein the handle comprises a first segment 22A and a second segment 22B. The first segment 22A may be articulably joined to the head portion 24 of the duster implement 12C, while the second segment 22B is rigidly joinable to the first segment 22A. The second segment 22B is rigidly joinable to the first segment 22A by snap locking or other known means. The first segment 22A and second segment 22B are juxtaposed in a generally aligned relationship by a sleeve 16 holding the first segment and second segment together although other configurations are feasible. The duster head portion 24 of the duster implement 12C may be at least partially external to the sleeve 16. The sleeve 16 further contains at least one duster cleaning refill 14 (not pictured). A suitable handle 22 may be made according to commonly assigned Des. 420,561 or D578,720 S. The handle 22 of the duster implement 12C may comprise one or more tines. The one or more tines may be elongate and sized to receivably and removably fit into the corresponding one or more duster cleaning refills 14. The duster cleaning refill 14 may then be held in place on the implement 12C by friction and or mechanical engagement. The implement 12C may be made according to U.S. Pat. Nos. 6,813,801 B2; 7,451,517 and/or 2002/0148061 A1.

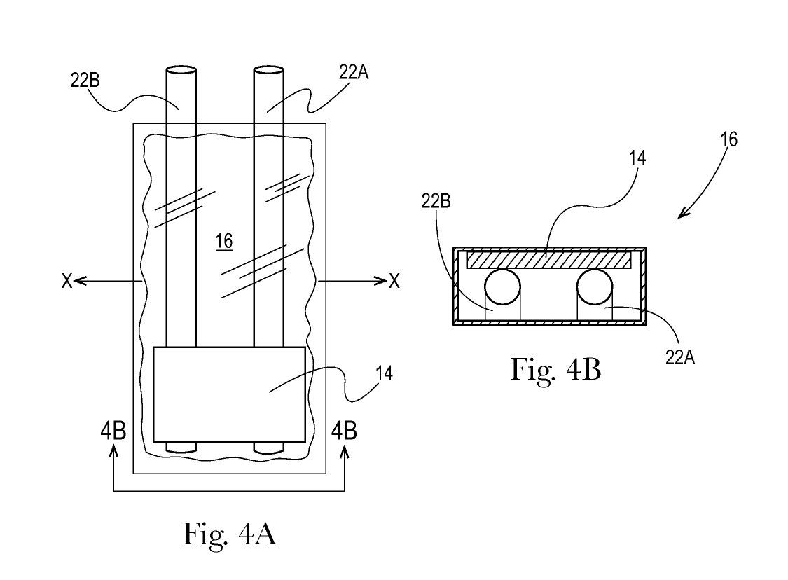

Examining the invention in more detail, FIG. 4A shows a frontal cutaway view of a sleeve 16 able to be used with any of the cleaning systems 10 described above. The sleeve 16 holds the first segment 22A and second segment 22B of the desired cleaning implements 12 in a generally aligned relationship. In this embodiment, the first segment 22A and second segment 22B may be separated by a distance in between them in the direction of the x axis. The distance between the segments can be varied so long as the first segment 22A and the second segment 22B remain in a generally aligned relationship. “Generally aligned” means that the segments are identically or substantially parallel to each other. In another embodiment, the first segment 22A and second segment 22B are skewed. In another embodiment, the first segment 22A and second segment 22B are in contact within the sleeve 16. In another embodiment, the first segment 22A and second segment 22B are touching opposite and opposing sides of the sleeve 16.

The sleeve 16 may be made of any material that is able to hold the first segment 22A and second segment 22B of the cleaning implement 12, as well as the cleaning refill 14, together. In one embodiment, the sleeve 16 is made of a cellulosic material such as tissue grade paper and/or paperboard. In another embodiment, the sleeve 16 is made of plastic; in another embodiment the sleeve 16 is made entirely of shrink-wrap; in another embodiment, the sleeve 16 is made of a panel at least partially surrounded by shrink-wrap. In another embodiment, the sleeve 16 is made of a combination of materials.

The sleeve 16 is situated on the cleaning implement 12 such that at least a portion of the head 24 of the cleaning implement 12 is external to the sleeve 16. In one embodiment, the entire head 24 is external to the sleeve 16.

FIG. 4B shows a close-up view of the bottom portion of the sleeve 16. In this embodiment, the bottom portion of the sleeve 16 is open. In another embodiment, the bottom portion of the sleeve 16 is closed. Along with the first segment 22A and the second segment 22B in a generally aligned relationship, the sleeve 16 contains at least one cleaning refill 14. This allows the consumer to go longer without having to return to the store to purchase additional refills for the implement, and also helps the consumer to identify the refill that may be needed upon future purchase. The cleaning refill 14 may be located in the bottom quadrant of the sleeve 16, behind the first and second segments 22A,B. “Quadrants” refers to areas of the sleeve 16 longitudinally spaced from the top to the bottom. In another embodiment, the cleaning refill 14 may be located in front of the first and second segments 22A,B. The cleaning refill 14 may be located any position along the longitudinal axis of the sleeve 16 so long as it is contained within the sleeve 16. This is important for protection of the refill 14 during shipment to and from the store.

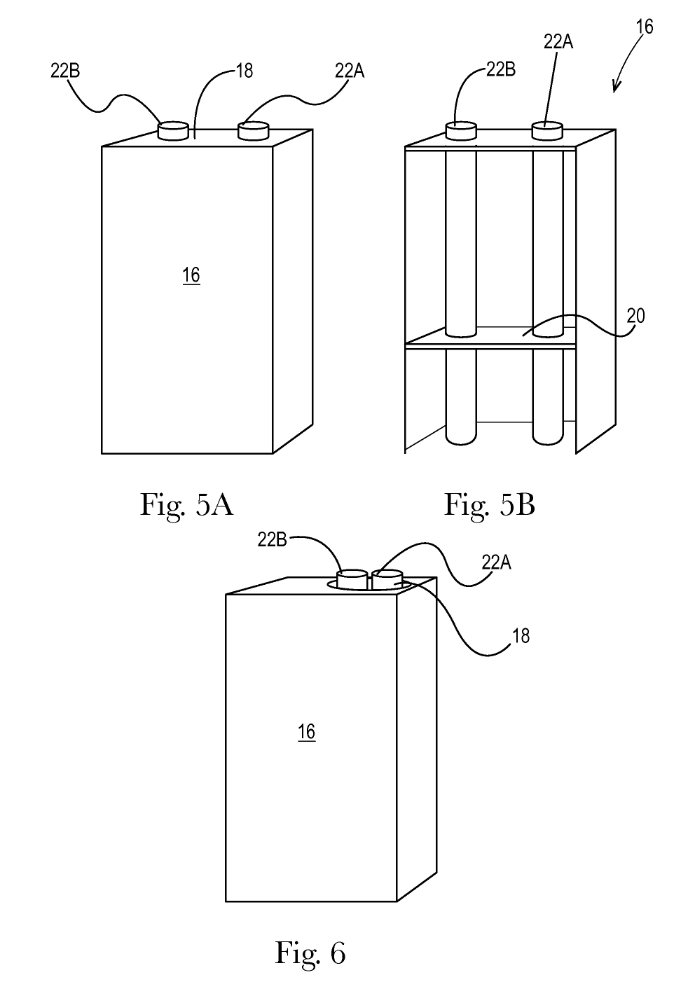

In FIG. 5A, the sleeve 16 further contains a collar 18 fitted within the sleeve 16. The collar 18 has an aperture containing at least two openings through which the first segment 22A and second segment 22B of the handle 22 extend through. The collar 18 may be made of the same material as the sleeve 16, or may be made of a different material than the sleeve 16. In this embodiment, the collar 18 is located in the top quadrant of the sleeve 16 and is flush with the top end of the sleeve 16. In another embodiment, the collar 18 is disposed in any quadrant of the sleeve 16 and extends laterally across the entire sleeve 16. The collar 18 provides for increased torque of the segments contained within the sleeve 16.

FIG. 5B shows an embodiment in which the sleeve 16 has a major axis and at least one end panel perpendicular thereto, and where there is a second collar 20 having a second aperture containing at least two openings to hold the first segment 22A and second segment 22B of the implement 12 in a generally aligned relationship. The first segment 22A and second segment 22B of the implement 12 extend through both the first collar 18 and through the second collar 20. The second collar 20 may be located in any quadrant of the sleeve 16, and be made of the same material or a different material than the first collar 18. In this embodiment, the second collar 20 extends laterally across the entire sleeve 16.

FIG. 6 shows an embodiment in which the sleeve 16 contains a collar 18 fitted within the sleeve 16, the collar 18 having an aperture containing one opening through which the first segment 22A and the second segment 22B of the handle 22 extend through. Within the one opening, the first and second segments 22A,B may be in contact, or they may have a distance between them in the direction of the x axis. In another embodiment, the segments 22A,B are further contained within the sleeve 16 by twist tie, wire tire, or rubber band.

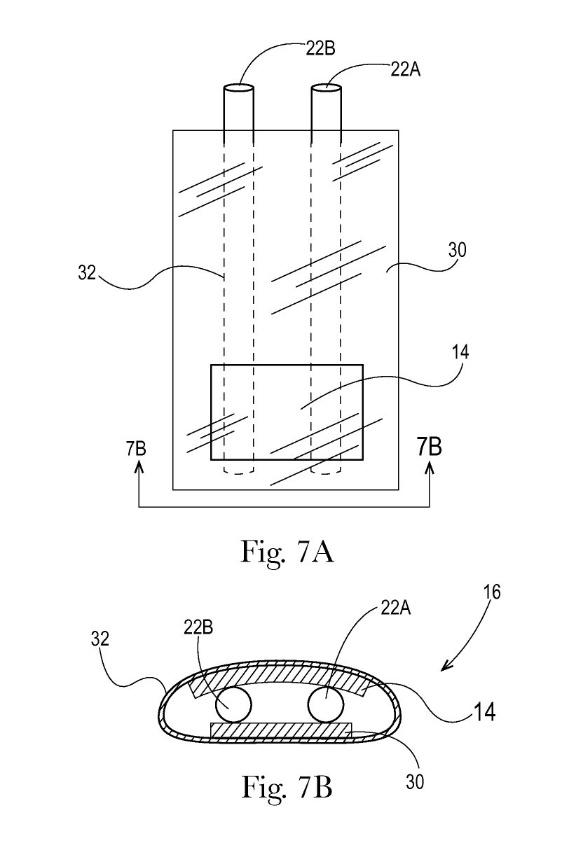

The sleeve 16 may have various configurations so long as it is able to hold the first and second segments 22A,B together and at least one cleaning refill 14. In FIG. 7A, the sleeve 16 is a rigid panel 30 with shrink-wrap 32 there around. By “rigid,” it is meant that the panel is not able to be materially deformed through such actions as tearing or bending, but that minor creasing is ok. The shrink-wrap 32 holds the first segment 22A and second segment 22B in a juxtaposed relationship and contains at least one cleaning refill 14 in any alignment as stated above. By shrink-wrapping the segments, the consumer is able to see inside of the sleeve 16 and fully view the implement 12 before purchase.

In FIG. 7A, a panel 30 has a rectangular geometry and the cleaning refill 14 has a rectangular geometry, and the geometries of the panel 30 and the cleaning refill 14 match. By “match” it is meant that the geometries are identical in shape and size. In another embodiment, the panel 30 has a geometry smaller than the geometry of the cleaning refill 14 with the cleaning refill 14 folded to fit therein. For clarity, the smaller dimension refers to a linear dimension. In the sleeve 16, the first segment 22A of the handle is joined to the head portion 24 at a first end and has a second end remote there from. The second segment 22B has a first end juxtaposed with the first end of the first segment 22A, and a second end juxtaposed with the second end of the first segment 22A. In this embodiment, the shrink-wrap 32 is then disposed around the first segment 22A and second segment 22B. In one embodiment, the panel 30 has a major avis generally aligned with the first and second segments 22A,B disposed within. In one embodiment, the panel 30 has indicia thereon.

FIG. 7B shows a close-up view of the bottom portion of the sleeve 16. Along with the first segment 22A and the second segment 22B in a generally aligned relationship, the sleeve 16 contains at least one cleaning refill 14. The cleaning refill 14 may be located in the bottom quadrant of the sleeve 16, behind the first and second segments 22A,B. In another embodiment, the cleaning refill may be located in front of the first and second segments 22A,B. The cleaning refill 14 may be located any position along the longitudinal axis of the sleeve 16 so long as it is contained within the sleeve 16. In one embodiment, the shrink-wrap 32 completely circumscribes the panel 30; in another embodiment, the shrink-wrap 32 only partially circumscribes the panel 30.

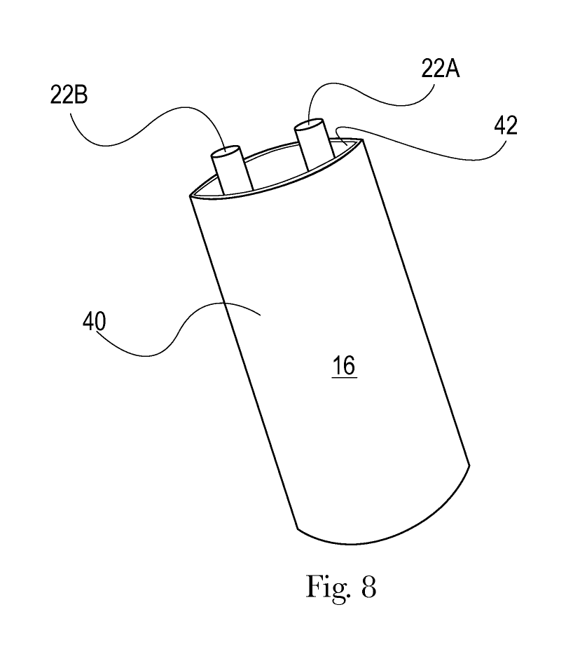

FIG. 8 shows another embodiment of the sleeve 16 in which the sleeve 16 comprises two elongated convex and opposed panels, a first panel 40 and a second panel 42, joined together at longitudinal edges to form a hollow space there-between. This sleeve configuration is simple to design and execute while still providing the benefit of holding the first segment 22A and second segment 22B in a generally aligned relationship. A cleaning refill 14 (not shown) is further contained within the sleeve 16. In one embodiment, the sleeve 16 is a cellulosic parallele pipedally shaped sleeve having a major axis generally aligned with the first segment 22A and the second segment 22B.

The sleeve 16 can have numerous dimensions. In one embodiment, the sleeve 16 has a length of from about 45.72 cm to about 127 cm, in another embodiment from about 49 cm to about 116.8 cm; in another embodiment from about 50.8 cm to about 76.2 cm. In one embodiment, the sleeve 16 has a width of from about 10.6 cm to about 30.54 cm; in another embodiment from about 24.89 cm to about 29.9 cm. In one embodiment, the sleeve 16 has a height of from about 12.7 cm to about 22.8 cm; in another embodiment from about 14.47 cm to about 20.3 cm.

The cleaning systems 10 according to the present invention may be displayed in one or more arrays 50 to make the purchase and the purchase decision more convenient. The array 50 may be in a brick and mortar store, a catalogue, on the internet, etc. The brick and mortar store may be a hardware store, grocery store, club store, kiosk, etc. The internet may use a dedicated website, a shopping website, a social media website, etc.

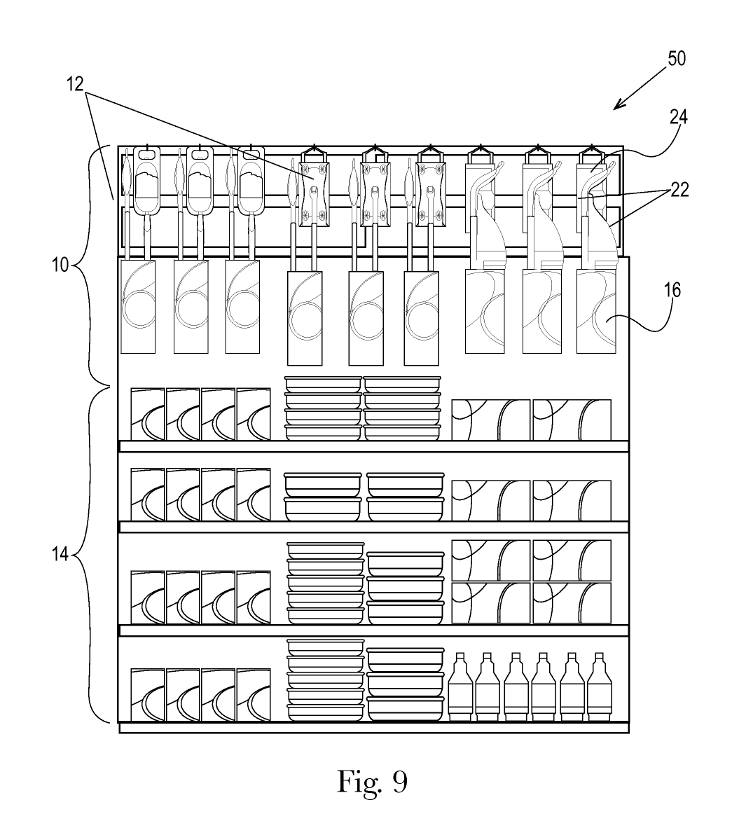

Referring to FIG. 9, the array 50 may comprise one or more of the cleaning systems 10 described above disposed at a first height and a plurality of cleaning refills 14 useable with the cleaning systems 10 disposed at a second height. In this embodiment, the second height is lower than the first height so that the cleaning systems 10 are disposed above the respective refills 14 used within, or vice versa. The cleaning systems described herein allow for respective refills 14 to be stocked underneath the respective cleaning systems 10. This arrangement effectively utilizes store space and mitigates consumer confusion. When hanging in the array 50, cleaning system 10A and 10B may have a hanging length of from about 40 inches to about 50 inches; in another embodiment from about 45 inches to about 47 inches. When hanging in the array 50, cleaning system 10C may have a hanging length of from about 20 inches to about 30 inches, in another embodiment from about 25 inches to about 27 inches.

In one embodiment, the array 50 has a first system 10, a second system 10, and a third system 10 and a respective first refill 14, second refill 14, and third refill 14, wherein each system 10 is associated with its respective refill 14 by being vertically aligned therewith. In addition or alternatively, each cleaning system 10 may be associated with its respective refill 14 by color. In one embodiment, each cleaning system 10 may be displayed in a vertical orientation with the head of the implement 12 being at the top of the array 50 and the sleeve 16 pointing towards the bottom of the array 50. In another embodiment, the head 24 of the implement 12 is upside down at the bottom of the array 50. The cleaning system 10 may be hung by cantilevered brackets as are known in the art.

The cleaning systems 10 disposed at a first height may comprise numerous cleaning systems 10 such as dry sheet cleaning systems 10, wet sheet cleaning systems 10, wettable sheet cleaning systems 10, duster cleaning systems 10, spray cleaning systems 10, etc. The number of cleaning systems 10 in the first array 50 may vary depending on the particular store display.

Each cleaning system 10 in the array 50 may comprise packaging for that cleaning system 10 and/or advertising of that system 10. The packages, the products therein, and advertisements therefore may comprise or predominantly comprise, colors of a common hue. As used herein, the hue is the property of the color, as reflected from the object, which allows that color to be classified as red, orange, yellow, green, blue, indigo, violet or a gradation thereof. The cleaning systems 10 having colors of a common hue may be distinguished by having mutually different shades. As used herein shade refers to how light or dark the color appears to the viewer.

The hue, and a particular shade thereof, may be associated with the trade dress and/or trademark of that product. The products, packaging and/or advertisements may exhibit a common brand and/or trademark.

Furthermore, the systems 10 may show a photograph, figure or other indicium of the respective cleaning refill or implement. The photograph or figure may particularly help the consumer understand specific differences between implements and refills.

Cleaning systems 10 in the array 50 may also be differentiated according to functionality. For example, implements 12 on one side of the array 50 may have features or functionality not found in implements 12 on the other side of the array 50.

The dimensions and other values disclosed herein are not to be understood as being strictly limited to the exact numerical values recited. Instead, unless otherwise specified, each such value is intended to mean both the recited value and a functionally equivalent range surrounding that value. For example, a dimension disclosed as “40 mm” is intended to mean “about 40 mm ”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning system, said cleaning system comprising a head and handle, said handle comprising a first segment and a second segment, said first segment being articulably joined to said head, and said second segment being rigidly joinable to said first segment, wherein said first segment and said second segment are juxtaposed in a generally aligned relationship, and further comprising a sleeve holding said first and second segments together in said generally aligned relationship, said sleeve further containing at least one cleaning refill removably attachable to said head, wherein at least a portion of said head is external to said sleeve.

2. The cleaning system of claim 1, wherein said sleeve comprises shrink-wrap, said shrink-wrap being disposed around said first and second segments.

3. The cleaning system of claim 2, wherein said first segment is joined to said head at a first end and has a second end remote there from, wherein said second segment has a first end juxtaposed with said first end of said first segment, and a second end juxtaposed with said second end of said first segment, wherein said shrink-wrap is juxtaposed with said second ends of said first segment and said second segment.

4. The cleaning system of claim 1, wherein said sleeve comprises two elongated convex and opposed panels joined together at longitudinal ends to form a hollow space there between.

5. The cleaning system of claim 1, wherein said implement is a dry sweeper.

6. The cleaning system of claim 1, wherein said implement is a spray sweeper.

7. The cleaning system of claim 1, wherein said entire head is external to said sleeve.

8. A cleaning system as displayed for sale, said cleaning system comprising a head and handle joined thereto, said handle comprising a first segment and a second segment, said first segment being articulably joined to said head, and said second segment being rigidly joinable to said first segment, wherein said first segment and said second segment are juxtaposed in a generally aligned relationship for sale, wherein the cleaning implement is further disposed on a rigid panel with shrink wrap there around to hold said first and second segments in said juxtaposed relationship, and further containing at least one cleaning refill disposed on said panel.

9. The cleaning system of claim 8, wherein said panel has a rectangular geometry and said cleaning refill has a rectangular geometry, and wherein said rectangular geometries match.

10. The cleaning system of claim 9, wherein said panel has a geometry smaller than the geometry of said cleaning refill, said refill being folded to fit therein.

11. The cleaning system of claim 10, wherein said panel has a major axis generally aligned with said first and second segments disposed therein.

12. The cleaning system of claim 8, wherein said panel has indicia thereon.

13. An array of cleaning systems for sale, each of said cleaning systems comprising a head and handle for sale, said handle comprising a first segment and a second segment, said first segment being articulably joined to said head, and said second segment being rigidly joinable to said first segment, wherein said first segment and said second segment are juxtaposed in a generally aligned relationship, and further comprising a cellulosic parallelepipedally shaped sleeve having a major axis generally aligned with said first and second segments, and holding said first and second segments together, said sleeve further containing at least one cleaning refill, wherein said array comprises a plurality of said cleaning systems disposed at a first height and a plurality of cleaning system refills useable with said cleaning systems and disposed at a second height, said second height being lower than said first height, so that said systems are disposed above respect refills usable therewith.

14. The array according to claim 13, further comprising a collar fitted within said sleeve, said collar having an aperture there through, said first and second segments of said handle extending through said aperture.

15. The array according to claim 14, wherein said collar is free floating in the middle two quadrants of said sleeve and wherein said collar extends laterally across the entire sleeve.

16. The array according to claim 15, wherein said sleeve has a major axis and at least one end panel perpendicular thereto, and further comprises a second aperture disposed in said end panel, wherein said first and second segments extend through both said first aperture and said second aperture.

17. The array according to claim 13, having a first system, a second system, and a third system and a respective first refill, second refill, and third refill, wherein each system is associated with its respective refill by being vertically aligned therewith, and wherein each system is associated with its respective refill by color.

18. The array according to claim 17, wherein each system is displayed in a vertical orientation with said head being at the top of said array.
